(19) United States
(12) Patent Application Publication
(10) Pub. No.: US 2016/0121277 A1
(43) Pub. Date: May 5, 2016

(54) AGITATOR SHAFT OF A FERMENTER AND METHOD FOR FASTENING AGITATING ARMS

(71) Applicant: HITACHI ZOSEN INOVA AG, Zürich (CH)

(72) Inventors: Florian MÜLLER, Flawil (CH); Hans-Peter KIENTZ, Singen (DE)

(21) Appl. No.: 14/897,268

(22) PCT Filed: Jun. 6, 2014
(86) PCT No.: PCT/EP2014/061838

§ 371 Date: Dec. 10, 2015

(30) Foreign Application Priority Data
Jun. 10, 2013 (CH) 01091/13

(51) Int. Cl. B01F 7/00

(52) U.S. Cl. CPC B01F 7/001; B01F 7/00291

(57) ABSTRACT

In the case of an agitator shaft of a fermenter of a biogas plant, including agitator brackets, which are arranged on a shaft wall and on which at least one agitating arm, including an agitating arm fastening portion and a blade carrier can be connected to the agitator brackets by fastening two agitating arm fastening plates of the agitating arm, it is intended to provide a method that achieves easier and quicker assembly of an agitator shaft and integration in a fermenter in situ, whereby a considerable cost saving in the setting up of a fermenter is achieved. This is achieved by cutting out fastening holes in the agitator brackets and cutting out through-holes in the agitating arm fastening plates in such a way that a plurality of retaining ring bolts can be arranged so as to pass completely through the fastening holes and the through-holes and can be riveted therein.

### TECHNICAL FIELD

The present invention describes an agitator shaft of a fermenter of a biogas plant with at least one agitator bracket arranged on a shaft wall and on which at least one agitating arm, comprising an agitating arm fastening portion and a blade carrier, can be connected to the at least one agitator bracket by means of fastening two agitating arm fastening plates of the agitating arm,

a method for fastening a plurality of agitating arms on an agitator shaft, which is part of an agitator unit of a fermenter of a biogas plant, wherein the agitator shaft has a plurality of agitator brackets, on which agitating arm fastening plates of the agitating arm can be fastened, as well as a fermenter for a biogas plant having an agitator shaft and fastened agitating arms.

### PRIOR ART

Fermenters used in biogas plants are formed from a hollow body, through the interior of which the biomass that is to be fermented is supplied and thereby fermented. The biogas formed during anaerobic fermentation of the biomass is used to provide energy in the form of thermal and/or electric energy, while the fermented biomass or the biogenic waste materials can be used inter alia as fertilizers in the agricultural industry.

As described in the EP 1 841 853 of the applicant, fermenters of this kind have a traversing agitator unit that enables a plug-flow type operation of the fermenter with corresponding transport of the biomass, completely traversing the fermenter. The agitator unit here has an agitator shaft, which is arranged in the longitudinal direction in a horizontally aligned fermenter. A plurality of agitating arms extends in the radial direction away from the agitator shaft. Blades are fastened at the ends of the agitating arms spaced from the agitator shaft. Each agitating arm is welded to the agitator brackets in the region of its agitating arm fastening portion. A robust material-bonding permanent connection of each agitating arm to the agitator shaft is thereby achieved, which can absorb the torques that arise during operation.

The demands on biogas plants with regard to mechanical stress on the components are high, so that careful design and exact construction are very important. The biogas plants known up until now provide only few possibilities for pre-assembling the individual components so that a series of complicated construction steps has to be carried out in situ.

In order to build a commercially worthwhile biogas plant there is a trend towards the largest possible fermenters, which can even be fifty meters long or longer and have diameters of about ten meters. As a result of such fermenter lengths, pre-assembly in the factory is ruled out. The previously known agitator units are also assembled in situ and have corresponding lengths in order to be able to move the biomass through the entire fermenter. For manufacturing the agitator unit, several dozens of agitating arms have to be welded to the agitator shaft. Welding the agitating arms to the agitator shaft cannot be carried out in the factory since, due to the length of the agitator unit and of the agitating arms that protrude several meters radially away from the agitator shaft, a transport to the construction site is practically impossible otherwise. In order to ensure that a sufficiently strong connection of the agitating arms to the agitator shaft is achieved, the technical expert has welded the components to one another. To guarantee a reliable connection of each individual agitating arm to the agitator shaft, the individual welding connections have to be additionally checked in quality control after the lengthy welding process.

The technical expert will already have the welding process optimized and possibly arranged spot seams between the agitating arm fastening portion and the agitator brackets instead of time-consuming continuous welding seams.

In order to achieve a more cost-effective assembly of the fermenter including an integrated agitator shaft, the number of agitating arms that are to be connected can be reduced to a minimum. The construction time for attaching the agitating arms is reduced accordingly, whereby the fermenter can be assembled more quickly. So that a sufficiently thorough mixing can take place, however, the shape and/or the size of the blades have to be adapted, for example. If the reduced number of blades has to move the same amount of biomass, then the forces acting on the blades, on the agitating arms, and on the agitator shaft are automatically larger, which needs to be taken into consideration as well. Inevitably, even more importance must be placed on the connection between the agitating arms and the agitator shaft. Agitating arms with greater wall thicknesses and a stabilized construction would have to be used. In order for these to be connected sufficiently strong to the agitator shaft, too, the technical expert would apply even more welding seams and by consequence inspect.

### PRESENTATION OF THE INVENTION

The present invention is concerned with the problem of providing a method that achieves a simplified and accelerated assembly of an agitator shaft and integration in a fermenter in situ, whereby a considerable reduction of costs is achieved during construction of a fermenter.

The assembly time necessary for the agitator shaft is reduced to a fraction of the time for the material-bonding connection of the individual agitating arms that is known from the prior art.

A further object was to provide an agitator shaft, which can be completed reliably and in reproducible manner in the shortest amount of time, without carrying out a quality control on each individual connection between each agitating arm and the agitator shaft.

Apart from the lengthy welding process for each individual agitating arm to existing agitator brackets, a quality control is necessary after each welding in order to check the satisfactory welding seam. Only with complete and sufficiently homogeneous welding seams can it be guaranteed that the radially protruding agitating arms can absorb the high torques during operation. By means of the method according to the present invention an accelerated fastening is possible, which required neither a long time welding experience nor a re-check of the fastening.

### BRIEF DESCRIPTION OF THE DRAWINGS

A preferred exemplary embodiment of the subject of the present invention is described below in connection with the accompanying drawings, in which

FIG. 1 shows a perspective view of an agitator shaft with an illustrated agitating arm;

FIG. 2 shows a view in the longitudinal direction of the agitator shaft;

FIG. 3 shows a perspective cross-sectional view of an agitating arm fastening portion along the line A-A of FIG. 2; and

FIG. 4 shows a two-dimensional cross-sectional view of the agitating arm fastening portion along the line A-A of FIG. 2.

### DESCRIPTION

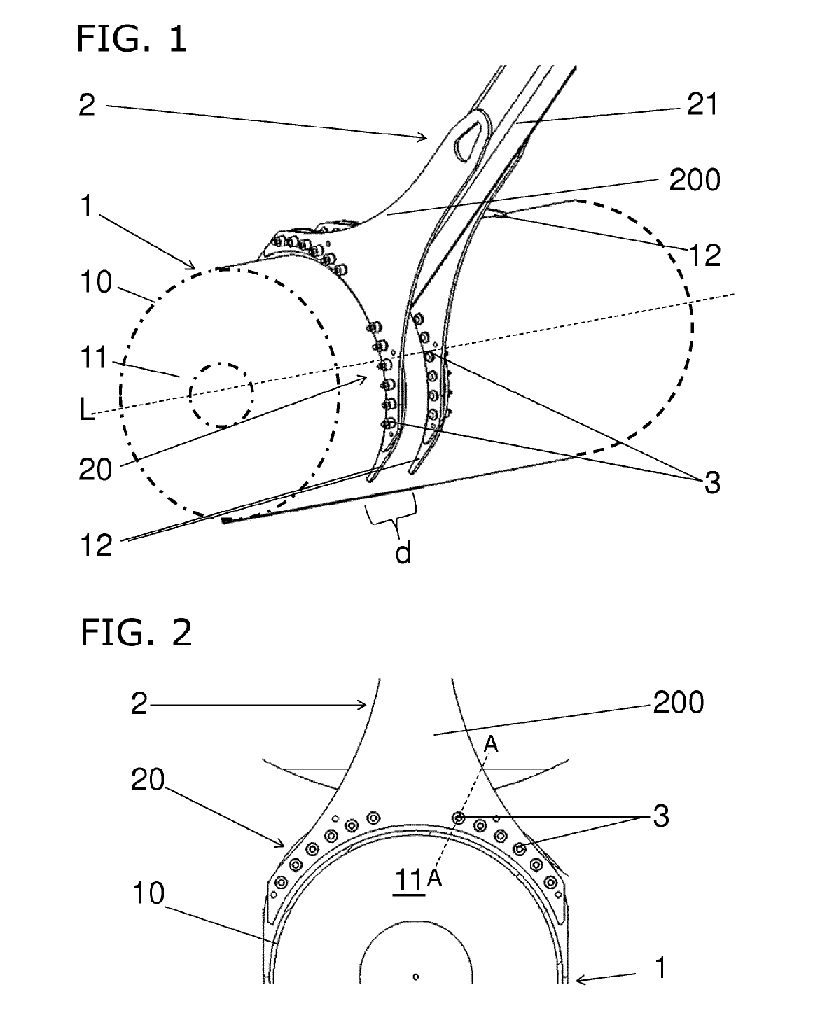

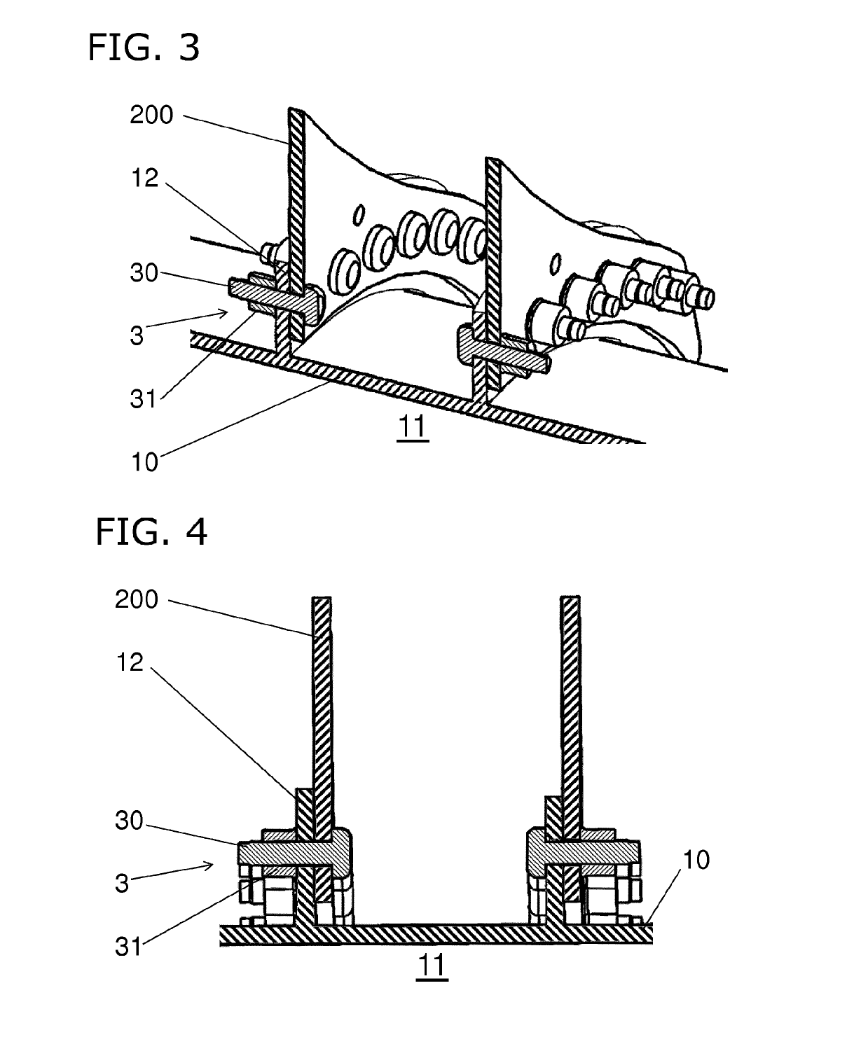

An agitator unit that can be operated in a fermenter of a biogas plant comprises an agitator shaft 1, which is in part shown here in FIG. 1. The agitator shaft 1 illustrated here is designed as a hollow shaft having a cylindrical shaft wall 10, which defines an interior 11 of the agitator shaft 1.

A plurality of agitating arms 2 is arranged on the shaft wall 10 spread out in the direction of the longitudinal axis L, whereby, for clarity, only one agitating arm 2 is shown here in the path of the agitator shaft 1. The agitating arms 2 are arranged pointing radially away from the agitator shaft 1 and off-set at different angles to one another. The agitating arm 2 has an agitating arm fastening portion 20, with which the agitating arm 2 is fastened to the agitator shaft 1. The agitating arm fastening portion has here two agitating arm fastening plates 200 running in parallel to one another, which are provided with a plurality of through-holes. The agitating arm fastening plates 200 are moulded to the agitating arm fastening portion 20 of the agitating arm 2.

The agitating arm 2 furthermore comprises a blade carrier 21, on the end facing away from the agitator shaft 1 of which, a blade is fastened, which is not shown here. The shaping of the blade can be configured differently. The blade carrier 21 is connected to the agitating arm fastening plates 200 and can be designed as a hollow profile. The strength of the blade carrier 21 must be adapted to the high torques and the forces occurring during circulating or transport of the biomass.

Agitator brackets 12 are arranged projecting radially from the outer peripheral surface of the agitator shaft 1. These are more advantageously moulded to the shaft wall 10, but can also be welded on. For reasons of stability, two agitator brackets 12 each running parallel to one another are configured along the outer peripheral face of the agitator shaft 1. The distance d between the agitator brackets 12 matches the agitating arms 2 that are to be assembled. Several fastening holes are recessed or drilled in the agitator brackets 12.

Agitating arm fastening plates 200 of the agitating arm 2 are semi-detachably fastened to the agitator brackets 12 by means of a plurality of fastening means 3.

The agitating arm 2 is positioned on the shaft wall 10 in such a way that the agitating arm fastening plates 200 of the agitating arm fastening portion 20 are arranged parallel to the agitator brackets 12. The fastening means 3 are then inserted so as to pass completely through the through-holes in the agitating arm fastening plates 200 and the fastening holes in the agitator brackets 12 and fastened. This allows for a welding-free fastening of the agitating arms 2 in the region of the agitating arm fastening portions 20, which is removable for repair purposes in the event of damage. As a result of the arrangement of the fastening means 3 spanning the periphery, the agitating arms 2 can be fastened such that the torques occurring during operation of the agitator unit in the fermenter can be absorbed without danger.

The use of retaining ring bolts 3 as fastening means 3 has proven to be particularly advantageous. The high torques acting on the blade carrier 21 or blades can be safely absorbed by a plurality of retaining ring bolts 3. An adequate safety factor can be achieved when using retaining ring bolts 3, since cases can also occur where foreign bodies in the fermenter have to be moved by the blades or even a temporary jamming of the blade carriers 21 can occur as a result of jammed foreign bodies.

The retaining ring bolt 3 comprises a bolt 30 with a grooved end and a retaining ring 31. The bolt 30 can be passed easily and quickly through the through-hole and the fastening hole of the components, which are to be connected. Subsequently, the closing ring 31 is pushed over the protruding end of the bolt 30, shaped with a setting tool around the end of the bolt 30 and thus semi-detachably connected to the bolt 30. The setting tool carries out a cold-forming of the retaining ring during hydraulic riveting, whereby a connection of the agitating arm fastening plate 200 to the agitator bracket 12 can be achieved, which is not susceptible to automatic loosening of the fastening means 3. Riveting can also be carried out pneumatically and/or electromechanically with respective setting tools. This type of connection can be easily achieved without instruction and with guaranteed quality when using the setting tool. There is no need, as is the case for screwing, to check a tightening torque of each fastening means 3. By using the retaining ring bolt 3, it is possible to achieve a vibration-resistant connection of the agitating arm 2 with the agitator bracket 12, wherein a significantly higher fatigue limit can be achieved than in the case of a screw-nut connection.

After assembling the agitating arms 2 on the agitator shaft 1, the agitator unit can be installed in the fermenter and the biogas plant can be put in operation after closing the fermenter. A costly transport of a pre-assembled agitator unit with radially protruding agitating arms 2 can be avoided. The overall assembly time of the fermenter is significantly reduced by the extremely rapid and reliable fixing of the agitating arms 2 on the agitator shaft 1 in situ.

### LIST OF REFERENCE NUMERALS

1 Agitator shaft
   10 shaft wall
   11 interior
   12 agitator bracket
      fastening hole
   d distance
   L longitudinal axis
2 Agitating arm
   20 agitating arm fastening portion
      200 agitating arm fastening plate through-hole
   21 blade carrier
3 Fastening means
   30 bolt
   31 retaining ring

1. An agitator shaft of a fermenter of a biogas plant with at least one agitator bracket arranged on a shaft wall and on which at least one agitating arm, comprising an agitating arm fastening portion and a blade carrier is connectable by means of fastening on at least one agitating arm fastening plate of the agitating arm on the at least one agitator bracket
wherein fastening holes are recessed in the at least one agitator bracket, and through-holes are recessed in the at least one agitating arm fastening plate so that a plurality of retaining ring bolts can be arranged so as to pass completely through the fastening holes and the through-holes and can be riveted therein.

2. The agitator shaft of a fermenter of a biogas plant as claimed in claim 1, wherein the retaining ring bolt comprises a bolt on whose end provided with ring grooves can be detachably fastened a retaining ring by cold-forming.

3. The agitator shaft of a fermenter of a biogas plant as claimed in claim 1, wherein the agitator shaft is designed as a hollow shaft and the agitator brackets are moulded to the shaft wall of the agitator shaft.

4. The agitator shaft of a fermenter of a biogas plant as claimed in claim 1, wherein the agitator arm fastening plates are moulded in an agitating arm fastening portion of the agitating arm.

5. A method for fastening a plurality of agitating arms on an agitator shaft, which is part of an agitator unit of a fermenter of a biogas plant, wherein the agitator shaft has a plurality of agitator brackets on which agitating arm fastening plates of the agitating arm can be fastened, wherein after arranging the agitating arm fastening plates relative to the agitating brackets a plurality of retaining ring bolts are passed completely through fastening holes in the agitator brackets and through-holes in the agitating arm fastening plates so that riveting the retaining ring bolts is then carried out with a setting tool.

6. The method for fastening a plurality of agitating arms on an agitator shaft as claimed in claim 5, wherein the riveting of the retaining ring bolts is carried out hydraulically, pneumatically and/or electromechanically with a corresponding setting tool.

7. The method as claimed in claim 5, wherein the retaining ring bolt comprises a bolt, on the end provided with ring grooves of which is detachably fastened a retaining ring by cold-forming.

8. A fermenter for a biogas plant comprising an agitator shaft, on the agitator brackets of which agitating arm fastening plates of an agitating arm are detachably arranged by means of retaining ring bolts, as claimed in claim 5.

9. The method as claimed in claim 6, wherein the retaining ring bolt comprises a bolt, on the end provided with ring grooves of which is detachably fastened a retaining ring by cold-forming.

10. A fermenter for a biogas plant comprising an agitator shaft, on the agitator brackets of which agitating arm fastening plates of an agitating arm are detachably arranged by means of retaining ring bolts as claimed in claim 6.

11. A fermenter for a biogas plant comprising an agitator shaft, on the agitator brackets of which agitating arm fastening plates of an agitating arm are detachably arranged by means of retaining ring bolts as claimed in claim 7.

12. A fermenter for a biogas plant comprising an agitator shaft, on the agitator brackets of which agitating arm fastening plates of an agitating arm are detachably arranged by means of retaining ring bolts as claimed in claim 9.
